(19) United States
(12) Patent Application Publication
(10) Pub. No.: US 2020/0062602 A1
(43) Pub. Date: Feb. 27, 2020

(54) METHOD FOR PRODUCING OLIGOSILANE

(71) Applicant: SHOWA DENKO K.K., Tokyo (JP)

(72) Inventors: Kiyoshi NOMURA, Tokyo (JP); Hiroshi UCHIDA, Tokyo (JP)

(73) Assignee: SHOWA DENKO K.K., Tokyo (JP)

(21) Appl. No.: 16/335,990

(22) PCT Filed: Sep. 19, 2017
(86) PCT No.: PCT/JP2017/033667

§ 371 Date: Mar. 22, 2019

(30) Foreign Application Priority Data
Sep. 23, 2016 (JP) 2016-186184

(51) Int. Cl. C01B 33/04; B01J 23/42; B01J 23/28; B01J 23/30; B01J 23/75; B01J 8/00

(52) U.S. Cl. CPC C01B 33/04; B01J 23/42; B01J 23/28; B01J 29/7884; B01J 23/75; B01J 8/008; B01J 23/30

(57) ABSTRACT

A method for producing an oligosilane including a reaction step of introducing a fluid containing a hydrosilane into a continuous reactor provided with a catalyst layer inside to produce an oligosilane from the hydrosilane and discharging a fluid containing the oligosilane from the reactor. The reaction step satisfies all of the following conditions (i) to (iii): (i) a temperature of the hydrosilane-containing fluid at an inlet of the catalyst layer is higher than a temperature of the oligosilane-containing fluid at an outlet of the catalyst layer; (ii) the temperature of the hydrosilane-containing fluid at the inlet of the catalyst layer is from 200 to 400° C.; and (iii) the temperature of the oligosilane-containing fluid at the outlet of the catalyst layer is from 50 to 300° C.

### TECHNICAL FIELD

The present invention relates to a method for producing an oligosilane.

### BACKGROUND ART

Oligosilanes such as hexahydrodisilane (Si₂H₆, hereinafter may be abbreviated as “disilane”) and octahydrotrisilane (Si₃H₈, hereinafter may be abbreviated as “trisilane”) are highly reactive as compared with tetrahydrosilane (SiH₄, hereinafter may be abbreviated as “monosilane”) and very useful compounds as, for example, precursors for the formation of amorphous silicon and silicon films.

The following methods for producing oligosilanes, for example, have been reported: the acid decomposition of magnesium silicide (refer to Non-Patent Document 1), the reduction of hexachlorodisilane (refer to Non-Patent Document 2), electric discharge in tetrahydrosilane (refer to Patent Document 1), the thermal decomposition of silane (refer to Patent Documents 2 to 3), and the dehydrogenative coupling of hydrosilanes such as tetrahydrosilane using a catalyst (refer to Patent Documents 4 to 10).

### PRIOR ART DOCUMENT

### Patent Documents

Patent Document 1: U.S. Pat. No. 5,478,453
Patent Document 2: Japanese Patent No. 4855462
Patent Document 3: Japanese Patent Application Laid-open No. H11-260729
Patent Document 4: Japanese Patent Application Laid-open No. H03-183613
Patent Document 5: Japanese Patent Application Laid-open No. H01-198631
Patent Document 6: Japanese Patent Application Laid-open No. H02-184513
Patent Document 7: Japanese Patent Application Laid-open No. H05-032785
Patent Document 8: Japanese Translation of PCT Application No. 2013-506541
Patent Document 9: WO2015/060189
Patent Document 10: WO2015/090996

### Non-Patent Documents

Non-Patent Document 1: Hydrogen Compounds of Silicon, 1. The Preparation of Mono- and Disilane, WARREN C. JOHNSON and SAMPSON ISENBERG, J. Am Chem. Soc., 1935, 57, 1349.
Non-Patent Document 2: The Preparation and Some Properties of Hydrides of Elements of the Fourth Group of the Periodic System and of their Organic Derivatives, A. E. FINHOLT, A. C. BOND Jr., K. E. WILZBACH and H. I. SCHLESINGER, J. Am Chem. Soc., 1947, 69, 2692.

### SUMMARY OF INVENTION

### Problem to be Solved by Invention

Although the oligosilane production method using the dehydrogenative coupling of a hydrosilane is an industrially excellent method with which an oligosilane can be produced at a relatively low cost using an inexpensive and readily available raw material, there has been room for improvement with this method with regard to the conversion of the reaction and the selectivity for a target oligosilane.

An object of the present invention is to provide an oligosilane production method with which a target oligosilane can be more efficiently produced.

### Solution to Problem

As a result of extensive and intensive investigations directed to solving the problem identified above, the present inventors found out that in the dehydrogenative coupling reaction of a hydrosilane in which an oligosilane is produced from the hydrosilane, the oligosilane can be more efficiently produced by controlling the reaction step to satisfy specific conditions. The present invention was achieved based on this finding.

That is, the present invention is as follows.

<1> A method for producing an oligosilane, comprising a reaction step of introducing a fluid containing a hydrosilane into a continuous reactor provided with a catalyst layer inside to produce an oligosilane from the hydrosilane and discharging a fluid containing the oligosilane from the reactor, wherein
the reaction step satisfies all of the following conditions (i) to (iii):
   (i) a temperature of the hydrosilane-containing fluid at an inlet of the catalyst layer is higher than a temperature of the oligosilane-containing fluid at an outlet of the catalyst layer:
   (ii) the temperature of the hydrosilane-containing fluid at the inlet of the catalyst layer is from 200 to 400° C.: and
   (iii) the temperature of the oligosilane-containing fluid at the outlet of the catalyst layer is from 50 to 300° C.
   <2> The method for producing an oligosilane according to <1>, wherein the temperature of the hydrosilane-containing fluid at the inlet of the catalyst layer is from 10 to 200° C. higher than the temperature of the hydrosilane-containing fluid at the outlet of the catalyst layer.
   <3> The method for producing an oligosilane according to <1> or <2>, wherein the hydrosilane-containing fluid is a gas containing hydrogen gas, and the hydrogen gas has a concentration of from 1 to 40 mol % in the hydrosilane-containing fluid.
   <4> The oligosilane production method according to any one of <1> to <3>, wherein the hydrosilane has a concentration of from 20 mol % to 95 mol % in the hydrosilane-containing fluid.
   <5> The oligosilane production method according to any one of <1> to <4>, wherein the hydrosilane-containing fluid is a gas, and the gas has a pressure of from 0.1 to 10 MPa at the inlet of the catalyst layer.
   <6> The method for producing an oligosilane according to any one of <1> to <5>, wherein the hydrosilane is tetrahydrosilane, and the oligosilane includes hexahydrodisilane.
   <7> The method for producing an oligosilane according to any one of <1> to <6>, wherein the catalyst layer comprises a catalyst containing, on the surface and/or in the interior of a support, at least one transition element selected from the group consisting of Periodic Table group 3 transition elements, group 4 transition elements, group 5 transition elements, group 6 transition elements, group 7 transition elements, group 8 transition elements, group 9 transition elements, group 10 transition elements, and group 11 transition elements.
   <8> The method for producing an oligosilane according to <7>, wherein the support is at least one selected from the group consisting of silica, alumina, titania, zirconia, zeolite, and activated carbon.
   <9> The method for producing an oligosilane according to <8>, wherein the zeolite has pores with a minor diameter of at least 0.41 nm and a major diameter of not more than 0.74 nm.
   <10> The method for producing an oligosilane according to <8>, wherein the support is a spherical or cylindrical molding of a powder containing alumina and a zeolite having pores with a minor diameter of at least 0.41 nm and a major diameter of not more than 0.74 nm, and has an alumina content (per 100 mass parts of the support not containing the alumina) of at least 10 mass parts and not more than 30 mass parts.
   <11> The method for producing an oligosilane according to any one of <7> to <10>, wherein the transition element is at least one transition element selected from the group consisting of Periodic Table group 4 transition elements, group 5 transition elements, group 6 transition elements, group 8 transition elements, group 9 transition elements, group 10 transition elements, and group 11 transition elements.
   <12> The method for producing an oligosilane according to <11>, wherein the transition element is at least one transition element selected from the group consisting of Periodic Table group 5 transition elements, group 6 transition elements, group 9 transition elements, and group 10 transition elements.
   <13> The method for producing an oligosilane according to <12>, wherein the transition element is at least one transition element selected from the group consisting of tungsten (W), molybdenum (Mo), cobalt (Co), and platinum (Pt).
   <14> The method for producing an oligosilane according to any one of <7> to <13>, wherein the catalyst comprises zeolite as the support and further contains, on the surface and/or in the interior of the zeolite, at least one main group element selected from the group consisting of Periodic Table group 1 main group elements and group 2 main group elements.

### Effect of the Invention

According to the present invention, oligosilane production is carried out more efficiently.

### BRIEF DESCRIPTION OF DRAWINGS

FIG. 1 is a cross sectional view (schematic diagram) of a continuous reactor that can be used in the oligosilane production method that is one aspect of the present invention.

FIG. 2(A) is a cross sectional view of another continuous reactor that can be used in the oligosilane production method that is one aspect of the present invention, and FIG. 2(B) is a schematic diagram showing temperature profiles.

FIG. 3(A) is a cross sectional view of still another continuous reactor that can be used in the oligosilane production method that is one aspect of the present invention, and FIG. 3(B) is a schematic diagram showing temperature profiles.

FIG. 4(A) is a cross sectional view of yet another continuous reactor that can be used in the oligosilane production method that is one aspect of the present invention, and FIG. 4(B) is a schematic diagram showing temperature profiles.

FIG. 5(A) is a cross sectional view of still another continuous reactor that can be used in the oligosilane production method that is one aspect of the present invention, and FIG. 5(B) is a schematic diagram showing temperature profiles.

FIG. 6 is a schematic diagram of the reaction apparatus that was used in the Examples and Comparative Examples of the present invention.

### DESCRIPTION OF EMBODIMENTS

Although specific examples will be described in the description of the details of the present invention, the present invention is not limited to the following description and can be appropriately modified in the execution insofar as there is no departure from the essential features of the present invention. In addition, each of the aspects described herein can be combined with any feature described by other aspects as long as such a combination can be carried out.

<Oligosilane Production Method>

The oligosilane production method that is one aspect of the present invention (hereinafter may be abbreviated as “production method of the present invention”) includes a reaction step of introducing a fluid containing a hydrosilane into a continuous reactor provided with a catalyst layer inside to produce an oligosilane from the hydrosilane and discharging a fluid containing the oligosilane from the reactor (hereinafter may be abbreviated as “reaction step”) and is characterized in that the reaction step satisfies all of the following conditions (i) to (iii):

(i) a temperature of the hydrosilane-containing fluid at an inlet of the catalyst layer is higher than a temperature of the oligosilane-containing fluid at an outlet of the catalyst layer;
(ii) the temperature of the hydrosilane-containing fluid at the inlet of the catalyst layer is from 200 to 400° C.; and
(iii) the temperature of the oligosilane-containing fluid at the outlet of the catalyst layer is from 50 to 300° C.

The present inventors found out that, in the dehydrogenative coupling reaction of a hydrosilane in which an oligosilane is produced from the hydrosilane, the oligosilane can be more efficiently produced by controlling the reaction to satisfy all of the above-described conditions (i) to (iii).

“Hydrosilane” herein refers to a silane compound having at least one silicon-hydrogen (Si—H) bond. “Oligosilane” herein refers to a silane oligomer provided by the coupling of a plurality of (2 to 5) individual (mono)silane molecules. “Dehydrogenative coupling” of a hydrosilane herein refers to a reaction in which the silicon-silicon (Si—Si) bond is formed by hydrosilane-to-hydrosilane coupling with the elimination of a hydrogen molecule (H₂), as represented by the following reaction formula.

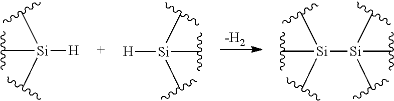

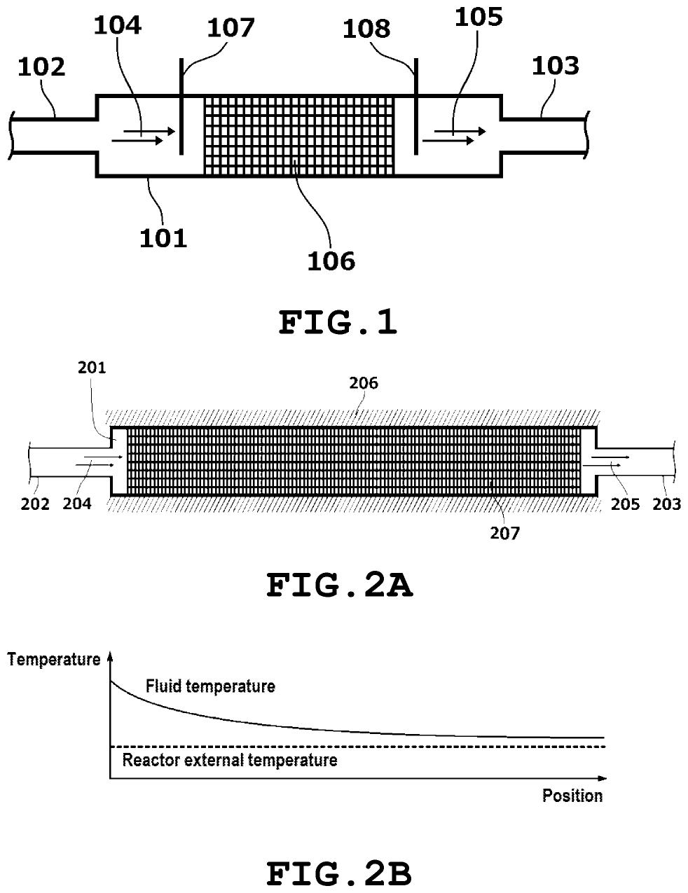

The reaction step in the production method of the present invention is a step of producing an oligosilane from a hydrosilane in a continuous reactor provided with a catalyst layer inside, and this step may be carried out for example using a reactor shown in FIG. 1. A reactor 101, which is connected to an introduction pipe 102 and a delivery pipe 103, is a continuous reactor capable of simultaneously performing introduction of a hydrosilane as a raw material and discharge of an oligosilane as a product. In addition, inside the reactor 101, a catalyst layer 106 is provided in a manner to be in contact with a fluid so that a fluid having passed through the catalyst layer 106 can be discharged.

The conditions (i) to (iii) above relate to “temperature of the hydrosilane-containing fluid at an inlet of the catalyst layer” and “temperature of the oligosilane-containing fluid at an outlet of the catalyst layer”, and “temperature of the hydrosilane-containing fluid at an inlet of the catalyst layer” corresponds to the temperature of a hydrosilane-containing fluid 104 immediately before coming into contact with the catalyst layer 106, and “temperature of the oligosilane-containing fluid at an outlet of the catalyst layer” corresponds to the temperature of an oligosilane-containing fluid 105 immediately after being discharged from the catalyst layer 106.

When a silane compound with n silicon atoms is introduced as a raw material into the continuous reactor and reacted, a silane compound with (n+1) silicon atoms is discharged as a main product from the outlet. This is considered to be caused by that in the seemingly dehydrogenative reaction as described above, silylene is produced as follows: monosilane yields silylene and hydrogen when monosilane (tetrahydrosilane) is used as a raw material, or disilane (hexahydrodisilane) yields silylene and silane (tetrahydrosilane) when disilane (hexahydrodisilane) is used as a raw material, and the produced silylene reacts with silanes and grows (silylene reacts with monosilane (tetrahydrosilane) to produce disilane (hexahydrodisilane) when monosilane (tetrahydrosilane) is used as a raw material, or silylene reacts with disilane (hexahydrodisilane) to produce trisilane (octahydrotrisilane) when disilane (hexahydrodisilane) is used as a raw material). That is, in the vicinity of the inlet of the catalyst layer, an unreacted raw material with n silicon atoms is abundant, and the dehydrogenative coupling reaction progresses with passing through the reactor, so that as the raw material with n silicon atoms gradually decreases, a product with (n+1) silicon atoms gradually increases. When the product is not recycled, the concentration of the silane compound with (n+1) silicon atoms at the inlet of the catalyst layer is zero.

For instance, in the case of a reaction step as represented by the following reaction formula where hexahydrodisilane (Si₂H₆) [with two silicon atoms] is produced from tetrahydrosilane (SiH₄) [with one silicon atom], in the vicinity of the inlet of the catalyst layer, unreacted tetrahydrosilane is abundant, and the dehydrogenative coupling reaction progresses with passing through the catalyst layer, so that the product, hexahydrodisilane increases.

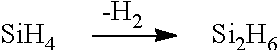

Thus, a concentration gradient occurs where the concentration of the raw material, tetrahydrosilane is high in the vicinity of the inlet of the catalyst layer and low in the vicinity of the outlet of the catalyst layer, whereas the concentration of the product, hexahydrodisilane is low in the vicinity of the inlet of the catalyst layer (the inlet concentration of disilane is zero when the product is not recycled in the production of disilane using monosilane as a raw material) and high in the vicinity of the outlet of the catalyst layer.

Since oligosilanes such as hexahydrodisilane are highly reactive as compared with tetrahydrosilane, by performing control so as to satisfy all of the conditions (i) to (iii) above, that is, by performing control so that the temperature is high in the vicinity of the inlet of the catalyst layer where the concentration of tetrahydrosilane is high while the temperature is low in the vicinity of the outlet of the catalyst layer where accumulated concentrations of hexahydrodisilane and higher oligosilanes are high, even though the reactivity of tetrahydrosilane is also decreased, side reactions due to further dehydrogenative reactions (via silylene) of more highly reactive oligosilanes such as hexahydrodisilane are suppressed, whereby a target oligosilane can be more efficiently produced.

Making the temperature in the vicinity of the outlet of the catalyst layer lower than the temperature in the vicinity of the inlet restrains catalyst deactivation caused by adhesion of hexahydrodisilane and/or higher oligosilanes to active sites on a catalyst, as a polysilane with a further higher molecular weight, whereby the reaction can be efficiently carried out.

It is noted that “temperature of the hydrosilane-containing fluid at an inlet of the catalyst layer” refers to the temperature of the fluid at the boundary where the catalyst layer appears, and for example, in the same way as a thermocouple 107 in FIG. 1, a thermocouple or the like may be placed at a position where the temperature of the fluid is approximately the same as that at the boundary of the catalyst layer to use the temperature observed thereby as the temperature of the fluid at the inlet of the catalyst layer. Likewise, as for “temperature of the oligosilane-containing fluid at an outlet of the catalyst layer”, for example, in the same way as a thermocouple 108 in FIG. 1, a thermocouple or the like may be placed at a position where the temperature of the fluid is approximately the same as that at the boundary of the catalyst layer to use the temperature observed thereby as the temperature of the fluid at the outlet of the catalyst layer. Since a fluid and a thermocouple are usually in thermal equilibrium, temperatures measured by the thermocouples may be considered to be the temperatures of the fluids. The temperature may of course be measured by other methods.

“Hydrosilane”, “oligosilane”, “reaction step”, and other steps or the like are described below in detail.

The specific species of the hydrosilane is not particularly limited as long as it is a compound having at least one silicon-hydrogen (Si—H) bond, and examples of a substituent (atom) other than the hydrogen atom and bonded to the silicon atom include hydrocarbon groups with 1 to 6 carbon atoms (including, for example, saturated hydrocarbon groups, unsaturated hydrocarbon groups, and aromatic hydrocarbon groups).

Examples of the hydrosilane include tetrahydrosilane (SiH₄), methyltrihydrosilane, ethyltrihydrosilane, phenyltrihydrosilane, and dimethyldihydrosilane. The hydrosilane as a raw material may be selected depending on a desired oligosilane to be produced.

The specific species of a target oligosilane is not particularly limited as long as it is a silane oligomer provided by the coupling of a plurality of (from 2 to 5) individual (mono)silane molecules, and a target oligosilane may have, for example, a branched structure, crosslinked structure, or cyclic structure.

The number of silicon atoms of the oligosilane is preferably from 2 to 4, more preferably from 2 to 3, and still more preferably 2 (when monosilane is used as the hydrosilane).

Examples of the oligosilane include hexahydrodisilane (Si₂H), octahydrotrisilane (Si₃H₈), decahydrotetrasilane (Si₄H₁₀), dimethyltetrahydrodisilane ((CH₃)₂Si₂H₄), and tetramethyldihydrodisilane (CH₃)₄Si₂H₂).

The reaction step is a step satisfying all of the conditions (i) to (iii) above. The specific temperatures of the hydrosilane-containing fluid at the inlet of the catalyst layer and the oligosilane-containing fluid at the outlet of the catalyst layer are not particularly limited as long as the temperatures satisfy (i) to (iii) and may be selected as appropriate according to the purpose.

The difference between the temperature of the hydrosilane-containing fluid at the inlet of the catalyst layer and the temperature of the oligosilane-containing fluid at the outlet of the catalyst layer (the temperature of the hydrosilane-containing fluid at the inlet of the catalyst layer—the temperature of the oligosilane-containing fluid at the outlet of the catalyst layer) is preferably at least 10° C., more preferably at least 30° C., and still more preferably at least 50° C., and is preferably not more than 200° C., more preferably not more than 170° C., and still more preferably not more than 150° C.

The temperature of the hydrosilane-containing fluid at the inlet of the catalyst layer is from 200 to 400° C., preferably at least 220° C., and more preferably at least 250° C., and preferably not more than 350° C., and more preferably not more than 300° C. When the temperature is at least 200° C., a good reaction conversion is secured, and when the temperature is not more than 400° C., side reactions are suppressed to some extent.

Although depending on the temperature at the inlet of the catalyst layer, the temperature of the oligosilane-containing fluid at the outlet of the catalyst layer is from 50 to 300° C., preferably at least 80° C., and more preferably at least 100° C., and preferably not more than 250° C., and more preferably not more than 200° C. When the temperature is at least 50° C., a good reaction conversion is secured, and when the temperature is not more than 300° C., side reactions are suppressed.

As described above, if within the indicated temperature ranges, oligosilane production can be carried out more efficiently.

In the reaction step, it is preferable to heat the hydrosilane-containing fluid with an external heat source and control the catalyst layer with a temperature control [cooling] unit (for example, by circulating a refrigerant through a jacket or the like) so that the outlet temperature of the fluid is lower than the inlet temperature of the fluid in the catalyst layer. For example, there is a configuration in which a reactor through which a fluid is caused to flow is provided with a catalyst-filled catalyst layer on the downstream side thereof, and a fluid preheating zone filled with no catalyst or filled with a filler (such as glass beads) having no catalytic activity is provided upstream of the catalyst layer, and the catalyst layer is under temperature control by a temperature control [cooling] unit. The temperature control of the catalyst layer for controlling the temperatures of the fluid at the inlet and outlet of the catalyst layer is described below in detail with specific examples.

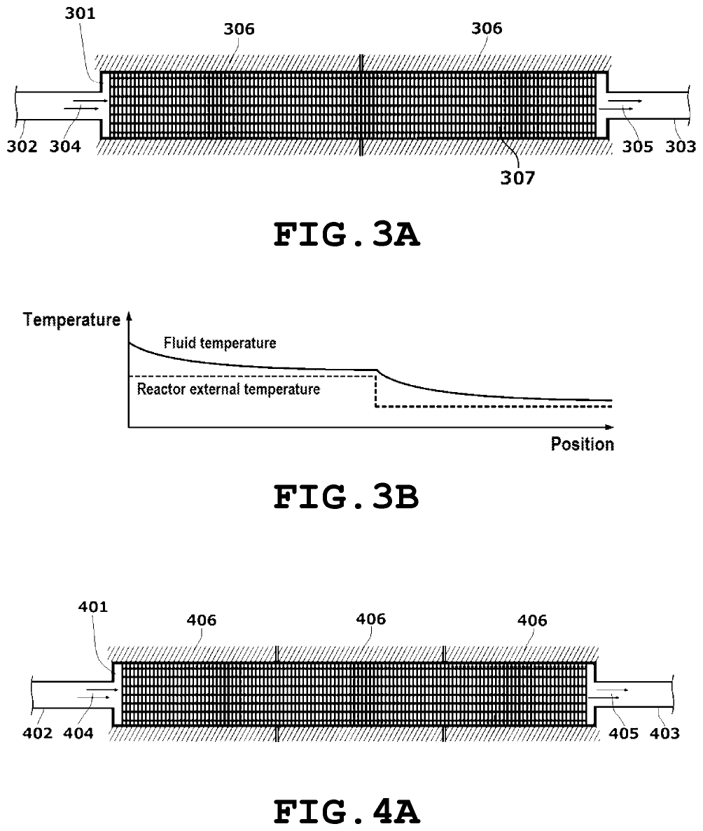

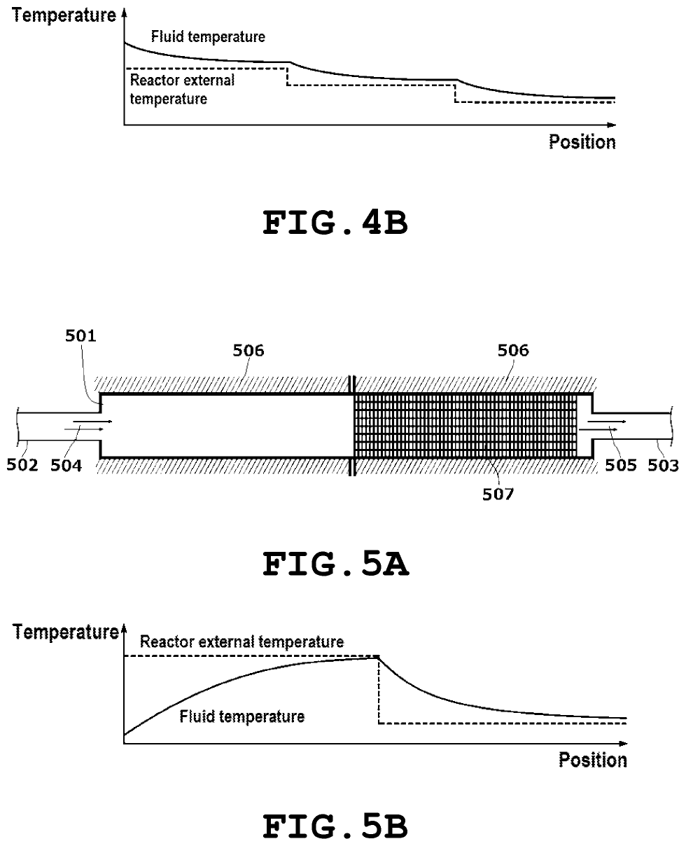

The temperature of the fluid can be decreased through the wall of the reactor by the temperature control [cooling] unit installed on the outside of the reactor. A reactor 201 in FIG. 2(A) is structured to be in contact with one temperature control [cooling] unit 206 from the inlet to the outlet as a whole. Temperature control [cooling] units 306 in FIG. 3(A) and temperature control [cooling] units 406 in FIG. 4(A) are a plurality of temperature control [cooling] units divided in the longitudinal direction of the reactor so as to be able to cause a stepwise change in the reactor external temperature.

An example of the temperature control [cooling] unit for decreasing the temperature of the fluid flowing through the catalyst layer is an inflow ofa refrigerant into a jacketed reaction apparatus. Examples of the refrigerant include the following: water vapor; organic refrigerants such as silicone oil, linear paraffin, biphenyl, biphenyl ether, and dibenzyltoluene; and inorganic refrigerants such as a mixture of sodium nitrite, sodium nitrate, and potassium nitrate. In addition, when a narrow small-scale reaction tube is used as in the Examples of the present invention to be described later, cooling may be carried out by air-cooling (the air corresponds to the refrigerant in this case) using, for example, a commercially available tubular furnace. In contrast, when a catalyst layer with a wide tube diameter is used, it is preferable to arrange a cooling tube such as a coil inside so that more efficient temperature control [cooling] can be performed on the catalyst layer.

When employing a configuration in which a preheating zone is provided upstream of a catalyst layer, it is preferable to place a preheater with a good heat exchange efficiency in the preheating zone.

When one temperature control [cooling] unit controls reactor external temperature from the inlet to the outlet of a catalyst layer, the reactor external temperature is generally at least 20° C., preferably at least 30° C., and more preferably at least 40° C., and is generally not more than 300° C., preferably not more than 280° C., and more preferably not more than 260° C., depending on the fluid temperatures at the inlet and outlet of the catalyst layer.

While the temperature of the hydrosilane-containing fluid at the inlet of the catalyst layer needs to be higher than the reactor external temperature at the inlet of the catalyst layer, when the temperature of the temperature control [cooling] unit (jacket) is constant as in FIG. 2(B), a gradual decrease in the temperature of the fluid makes the difference (ΔT) between the fluid temperature and the reactor external temperature smaller and deteriorates the heat exchange efficiency. As described above, it is therefore desirable to efficiently advances the temperature decrease by providing a plurality of temperature control [cooling] units (divide the jacket into sections) as in FIG. 3(A) and FIG. 4(A) and making the reactor external temperature on the downstream side further lower, which, however, involves increased apparatus costs and a complicated operation control method; therefore, the specification of the reactor should be determined considering cost-effectiveness.

The difference between the temperature of the hydrosilane-containing fluid at the inlet of the catalyst layer and the reactor external temperature (the temperature of the hydrosilane-containing fluid at an inlet of the catalyst layer—the reactor external temperature) is more preferably at least 20° C., and still more preferably at least 50° C.

If within the indicated ranges, oligosilane production can be carried out more efficiently.

It is noted that although FIG. 2(A) to FIG. 4(A) each illustrate a case where the catalyst layer is provided almost all across the reactor to simplify the descriptions, the catalyst layer may be provided only at part of the reactor in the manner as shown in FIG. 1. In that case, the temperature control [cooling] unit such as a jacket may be arranged at a position overlapping with at least part of the catalyst layer.

In FIG. 5(A), the upstream side of a reactor 501 is a preheating zone while a catalyst layer 507 is placed on the downstream side, and an external jacket is sectioned to thereby efficiently increase the temperature to the inlet temperature of the catalyst layer which serves as a reaction zone and decrease the temperature within the reactor where the catalyst layer is arranged.

The reaction step is a step including introducing a hydrosilane-containing fluid into a continuous reactor provided with a catalyst layer inside, and the hydrosilane concentration in the introduced fluid, the state of the fluid, a simple substance (such as a carrier gas to be described later) or compound contained in the fluid and other than the hydrosilane, the pressure of the fluid, and the like are not particularly limited and may be selected as appropriate according to the purpose. A detailed description is provided below with specific examples.

The hydrosilane concentration in the fluid at the inlet of the catalyst layer is generally at least 20 mol %, preferably at least 30 mol %, and more preferably at least 40 mol % and is preferably not more than 95 mol % and more preferably not more than 90 mol %. If within the indicated ranges, oligosilane production can be carried out more efficiently.

The fluid containing hydrosilane as a raw material is preferably a gas and more preferably a gas containing a carrier gas.

Examples of the carrier gas include inert gases such as nitrogen gas and argon gas and hydrogen gas, and it is particularly preferable to contain hydrogen gas.

While the dehydrogenative coupling of tetrahydrosilane (SiH₄) produces disilane (Si₂H₆) as shown in reaction equation (a) below, it is considered that a portion of the produced disilane decomposes, as shown in reaction equation (b) below, into tetrahydrosilane (SiH₄) and dihydrosilylene (SiH₂). It is also considered that the produced dihydrosilylene undergoes polymerization as shown in reaction equation (c) below to form a solid polysilane (SiH₂)ₙ, leading to a decrease in the oligosilane yield, for example.

When, on the other hand, hydrogen gas is present, it is considered that tetrahydrosilane is produced from dihydrosilylene as shown in reaction equation (d) below, the production of polysilanes is then suppressed, and as a consequence the oligosilane production can be carried out on a long-term and stable basis.

2Si—H₄→Si₂H₆+H₂ (a)

Si₂H₆→SiH₄+SiH₂ (b)

nSiH₂→(SiH₂)ₙ (c)

SiH₂+H₂→SiH₄ (d)

When the hydrosilane-containing fluid is a gas containing hydrogen gas, the concentration of the hydrogen gas at the inlet of the catalyst layer is preferably at least 1 mol %, more preferably at least 3 mol %, and still more preferably at least 5 mol % and is preferably not more than 40 mol %, more preferably not more than 30 mol %, and still more preferably not more than 20 mol %. If within the indicated ranges, the oligosilane production can be carried out more efficiently.

When the hydrosilane-containing fluid is a gas, the pressure at the inlet of the catalyst layer within the reactor, considered as the absolute pressure, is preferably at least 0.1 MPa, more preferably at least 0.15 MPa, and still more preferably at least 0.2 MPa and is preferably not more than 10 MPa, more preferably not more than 5 MPa, and still more preferably not more than 3 MPa. The hydrosilane partial pressure is preferably at least 0.0001 MPa, more preferably at least 0.0005 MPa, and still more preferably at least 0.001 MPa and is preferably not more than 10 MPa, more preferably not more than 5 MPa, and still more preferably not more than 1 MPa. If within the indicated ranges, oligosilane production can be carried out more efficiently.

When the hydrosilane-containing fluid is a gas containing hydrogen gas, the partial pressure of the hydrogen gas with respect to the sum of the partial pressure of hydrosilanes and the partial pressure of oligosilanes is from 0.05 to 5, preferably from 0.1 to 4, and more preferably from 0.02 to 2 (hydrogen gas/(hydrosilanes+oligosilanes)).

When the hydrosilane-containing fluid is caused to flow through using a continuous tubular reactor, the conversion is too low at short contact time with the catalyst (high flow rate) while polysilane production is facilitated if the contact time with the catalyst is too long, and a contact time of from 0.01 seconds to 30 minutes is preferable as a consequence.

Sometimes heat exchange through the reaction tube wall cannot catch up when the contact time is short; it is therefore preferable to additionally place, in the reaction tube, a coil or the like through which a refrigerant is passed so as to smoothly decrease the reaction temperature.

The reaction step is a step including discharging an oligosilane-containing fluid from the reactor, and examples of a simple substance or compound contained in the fluid and other than the oligosilane include unreacted hydrosilanes and a carrier gas.

The reaction step is a step including introducing a hydrosilane-containing fluid into a continuous reactor provided with a catalyst layer inside, and the catalyst is described in detail below with specific examples.

While the specific species of the catalyst is not particularly limited as long as it can be used for the dehydrogenative coupling of hydrosilanes, a particularly preferable catalyst is a heterogeneous catalyst containing a support and, on the surface and/or in the interior of the support, at least one transition element (hereinafter may be abbreviated as “transition element”) selected from the group consisting of Periodic Table group 3 transition elements, group 4 transition elements, group 5 transition elements, group 6 transition elements, group 7 transition elements, group 8 transition elements, group 9 transition elements, group 10 transition elements, and group 11 transition elements. It is considered that such transition elements promote the dehydrogenative coupling of hydrosilanes, resulting in production of oligosilanes at good efficiencies.

The “catalyst (hereinafter may be abbreviated as “transition element-containing catalyst”) containing, on the surface and/or in the interior of the support, at least one transition element selected from the group consisting of Periodic Table group 3 transition elements, group 4 transition elements, group 5 transition elements, group 6 transition elements, group 7 transition elements, group 8 transition elements, group 9 transition elements, group 10 transition elements, and group 11 transition elements is described in detail below.

Examples of the group 3 transition elements in the transition element-containing catalyst include scandium (Sc), yttrium (Y), lanthanoid (La), and samarium (Sm).

Examples of the group 4 transition elements include titanium (Ti), zirconium (Zr), and hafnium (Hf).

Examples of the group 5 transition elements include vanadium (V), niobium (Nb), and tantalum (Ta).

Examples of the group 6 transition elements include chromium (Cr), molybdenum (Mo), and tungsten (W).

Examples of the group 7 transition elements include manganese (Mn) and rhenium (Re).

Examples of the group 8 transition elements include iron (Fe), ruthenium (Ru), and osmium (Os).

Examples of the group 9 transition elements include cobalt (Co), rhodium (Rh), and iridium (Ir).

Examples of the group 10 transition elements include nickel (Ni), palladium (Pd), and platinum (Pt).

Examples of the group 11 transition elements include copper (Cu), silver (Ag), and gold (Au).

More preferred transition elements for use in the present invention are the group 4 transition elements, group 5 transition elements, group 6 transition elements, group 8 transition elements, group 9 transition elements, group 10 transition elements, and group 11 transition elements.

Still more preferred transition elements are the group 5 transition elements, group 6 transition elements, group 9 transition elements, and group 10 transition elements.

Examples of still more preferred specific transition elements include tungsten (W), vanadium (V), molybdenum (Mo), cobalt (Co), nickel (Ni), palladium (Pd), and platinum (Pt).

Among the preceding, tungsten (W), molybdenum (Mo), cobalt (Co), and platinum (Pt) are particularly preferred for the transition element.

The form and composition of the transition element in the transition element-containing catalyst are also not particularly limited, and, for example, the form may be that of a metal (a metal simple substance, an alloy) optionally having an oxidized surface or may be that of a metal oxide (a single metal oxide, a composite metal oxide). In addition, for example, the metal and/or metal oxide may be supported at the surface of the support (outer surface and/or within the pores) or the transition element may be introduced into the interior of the support (support framework) by ion exchange or composite formation.

Examples of the metal optionally having an oxidized surface include scandium, yttrium, lanthanoid, samarium, titanium, zirconium, hafnium, vanadium, niobium, tantalum, chromium, molybdenum, tungsten, manganese, technetium, rhenium, iron, ruthenium, osmium, cobalt, rhodium, iridium, nickel, palladium, platinum, copper, silver, and gold.

Examples of the metal oxide include scandium oxide, yttrium oxide, lanthanoid oxide, samarium oxide, titanium oxide, zirconium oxide, hafnium oxide, vanadium oxide, niobium oxide, tantalum oxide, chromium oxide, molybdenum oxide, tungsten oxide, manganese oxide, technetium oxide, rhenium oxide, iron oxide, ruthenium oxide, osmium oxide, cobalt oxide, rhodium oxide, iridium oxide, nickel oxide, palladium oxide, platinum oxide, copper oxide, silver oxide, gold oxide and their composite oxides.

Examples of the methods of loading the support with the transition element include impregnation and ion-exchange, which use a precursor in solution form, and a method in which a precursor is volatilized by, for example, sublimation, and vapor deposited on the support. Impregnation method is a method in which the support is brought into contact with a solution in which a transition element-containing compound is dissolved and the transition element-containing compound is thereby adsorbed to the surface of the support. Pure water is ordinarily used for the solvent, but organic solvents such as methanol, ethanol, acetic acid, and dimethylformamide, may also be used as long as they dissolve the transition element compound. Ion-exchange method is a method in which a support having acid sites, e.g., zeolite, is brought into contact with a solution in which an ion of the transition element is dissolved, thereby introducing the transition element ion at the acid sites on the support. Pure water is again ordinarily used as the solvent in this case, but organic solvents such as methanol, ethanol, acetic acid, and dimethylformamide, may also be used as long as they dissolve the transition element. Vapor deposition method is a method in which the transition element itself or the transition element oxide is heated in order to volatilize same by, e.g., sublimation, and thereby bring about its vapor deposition on the support. After the execution of an impregnation, ion-exchange, vapor deposition method, or the like, preparation of the metal or metal oxide form desired for the catalyst can be carried out by the execution of treatments such as drying, and calcination in a reducing atmosphere or an oxidizing atmosphere.

Examples of the precursor for the transition element-containing catalyst include, in the case of molybdenum, ammonium heptamolybdate, silicomolybdic acid, phosphomolybdic acid, molybdenum chloride, and molybdenum oxide. In the case of tungsten, the examples include ammonium paratungstate, phosphotungstic acid, silicotungstic acid, and tungsten chloride. In the case of titanium, the examples include titanium oxysulfate, titanium chloride, and tetraethoxytitanium. In the case of vanadium, the examples include vanadium oxysulfate and vanadium chloride. In the case of cobalt, the examples include cobalt nitrate and cobalt chloride. In the case of nickel, the examples include nickel nitrate and nickel chloride. In the case of palladium, the examples include palladium nitrate and palladium chloride. In the case of platinum, the examples include a nitric acid solution of diammine dinitro platinum (II) and tetraammine platinum (II) chloride.

While the specific species of the support of the transition element-containing catalyst is not particularly limited, examples thereof include silica, alumina, titania, zirconia, silica-alumina, zeolites, active carbon, and aluminum phosphate, and the support is preferably any one of silica, alumina, titania, zirconia, zeolites, and active carbon. Among these, zeolites are preferred, a zeolite having pores with a minor diameter of at least 0.41 nm and a major diameter of not more than 0.74 nm is preferred, and a zeolite having pores with a minor diameter of at least 0.43 nm and a major diameter of not more than 0.69 nm is particularly preferred. The pore space in the zeolite is considered to act as a reaction field for dehydrogenative coupling, and a pore size of “a minor diameter of at least 0.41 nm and a major diameter of not more than 0.74 nm” is considered to be optimal for suppressing excessive polymerization and bringing about an improved selectivity for an oligosilane.

It is noted that “a zeolite having pores with a minor diameter of at least 0.41 nm and a major diameter of not more than 0.74 nm” does not mean only zeolites that actually have “pores with a minor diameter of at least 0.41 nm and a major diameter of not more than 0.74 nm”, but also includes zeolites for which the pore “minor diameter” and “major diameter” as theoretically calculated from the crystalline structure respectively satisfy the aforementioned conditions. For the pore “minor diameter” and “major diameter”, reference can be made to “ATLAS OF ZEOLITE FRAMEWORK TYPES, Ch. Baerlocher, L. B. McCusker and D. H. Olson. Sixth Revised Edition 2007, published on behalf of the structure Commission of the International Zeolite Association”.

The minor diameter for the zeolite is at least 0.41 nm, preferably at least 0.43 nm, more preferably at least 0.45 nm, and particularly preferably at least 0.47 nm.

The major diameter for the zeolite is not more than 0.74 nm, preferably not more than 0.69 nm, more preferably not more than 0.65 nm, and particularly preferably not more than 0.60 nm.

When the pore diameter of the zeolite is constant because, for example, the cross-sectional structure of the pore is circular, the pore diameter is then regarded as “at least 0.41 nm and not more than 0.74 nm”.

When the zeolite has a plurality of pore diameters, then the pore diameter of at least one type of pore should be “at least 0.41 nm and not more than 0.74 nm”.

The specific zeolite is preferably a zeolite having a framework type code as provided in the database of the International Zeolite Association corresponding to the following: AFR, AFY, ATO, BEA, BOG, BPH, CAN, CON, DFO, EON, EZT, FAU, FER. GON, IMF, ISV, ITH, IWR, IWV, IWW, LTA, LTL, MEI, MEL, MFI, MOR, MWW, OBW, MOZ, MSE, MTT, MTW, NES, OFF, OSI, PON, SFF, SFG, STI, STF, TER, TON, TUN, USI, and VET.

Zeolites with framework type codes corresponding to the following are more preferred: ATO, BEA, BOG, CAN, IMF, ITH, IWR, IWW, MEL, MFI, OBW, MSE, MTW, NES, OSI, PON, SFF, SFG, STF, STI, TER, TON, TUN, and VET.

Zeolites with framework type codes corresponding to BEA, MFI, and TON are particularly preferred.

Examples of zeolites with a framework type code corresponding to BEA include *Beta, [B—Si—O]-*BEA, [Ga—Si—O]-*BEA, [Ti—Si—O]-*BEA, Al-rich beta, CIT-6, Tschernichite, and pure silica beta (the * indicates a mixed crystal of three polytypes with similar structures).

Examples of zeolites with a framework type code corresponding to MFI include *ZSM-5, [As—Si—O]-MFI, [Fe—Si—O]-MFI, [Ga—Si—O]-MFI, AMS-1B, AZ-1, Bor-C, Boralite C, Encilite, FZ-1, LZ-105, Monoclinic H-ZSM-5, Mutinaite, NU-4, NU-5, Silicalite, TS-1, TSZ, TSZ-III, TZ-01, USC-4, USI-108, ZBH, ZKQ-1B, ZMQ-TB, and organic-free ZSM-5 (the * indicates a mixed crystal of three polytypes with similar structures).

Examples of zeolites with a framework type code corresponding to TON include Theta-1, ISI-1, KZ-2, NU-10, and ZSM-22.

Zeolites ZSM-5, beta, and ZSM-22 are particularly preferred.

The silica-alumina ratio (mol/mol ratio) is preferably from 5 to 10,000, more preferably from 10 to 2,000, and particularly preferably from 20 to 1,000.

The overall transition element content in the transition element-containing catalyst (with reference to the mass of the support in a state containing the transition element, the main group element described below, and so forth) is preferably at least 0.01 mass %, more preferably at least 0.1 mass %, and still more preferably at least 0.5 mass % and is preferably not more than 50 mass %, more preferably not more than 20 mass %, and still more preferably not more than 10 mass %. If within the indicated ranges, a good reaction conversion can be secured, and side reactions due to excessive use can be suppressed. As a consequence, oligosilane production can be carried out more efficiently.

The transition element-containing catalyst preferably has the form of a molding provided by molding a powder into a spherical shape, cylindrical shape (pellet shape), ring shape, or honeycomb shape. A binder such as alumina and a clay compound, may be used in order to mold the powder. The strength of the molding cannot be maintained when the amount of binder use is too small; when the amount of binder use is too large, this has a negative effect on the catalytic activity. As a consequence, when alumina is used as the binder, the alumina content (per 100 mass parts of the support (powder) not containing the alumina) is generally at least 2 mass parts, preferably at least 5 mass parts, and more preferably at least 10 mass parts and is generally not more than 50 mass parts, preferably not more than 40 mass parts, and more preferably not more than 30 mass parts. If within the indicated ranges, negative effects on the catalytic activity can be suppressed while the strength of the support is maintained.

The transition element-containing catalyst preferably contains at least one main group element (hereinafter may be abbreviated as “main group element”) selected from the group consisting of Periodic Table group 1 main group elements and group 2 main group elements. The form and composition of the main group element in the catalyst is not particularly limited, but examples of the form include the metal oxide (single metal oxide, composite metal oxide) and the ion. In addition, when the catalyst is a support-containing heterogeneous catalyst, for example, the main group element may be supported in the form of the metal oxide or metal salt at the surface of the support (outer surface and/or within the pores) or the main group element may be introduced into the interior (support framework) by ion exchange or composite formation. The incorporation of such a main group element restrains the initial hydrosilane (monosilane) conversion to inhibit excessive consumption, and in combination with this can raise the initial disilane selectivity. In addition, the catalyst life can also be extended by restraining the initial hydrosilane conversion.

Examples of the group 1 main group elements include lithium (Li), sodium (Na), potassium (K), rubidium (Rb), cesium (Cs), and francium (Fr).

Examples of the group 2 main group elements include beryllium (Be), magnesium (Mg), calcium (Ca), strontium (Sr), barium (Ba), and radium (Ra).

Among the preceding, the incorporation of sodium (Na), potassium (K), rubidium (Rb), cesium (Cs), francium (Fr), calcium (Ca), strontium (Sr), and barium (Ba) is preferred.

Impregnation and ion exchange are examples of methods for incorporating the main group element into the transition element-containing catalyst. Impregnation is a method in which the support is brought into contact with a solution in which a main group element-containing compound is dissolved and the main group element is thereby adsorbed to the surface of the support. Pure water is ordinarily used for the solvent, but organic solvents such as methanol, ethanol, acetic acid, and dimethylformamide, can also be used as long as they dissolve the main group element-containing compound. Ion-exchange is a method in which a support having acid sites, e.g., zeolite, is brought into contact with a solution in which an ion of the main group element is dissolved, thereby introducing the main group element ion at the acid sites on the support. Pure water is also ordinarily used as the solvent in this case, but organic solvents such as methanol, ethanol, acetic acid, and dimethylformamide, can also be used as long as they dissolve the main group element ion. Treatments such as drying and firing may be carried out after the execution of impregnation or ion-exchange.

In the case of the incorporation of lithium (Li), examples of the solution include an aqueous lithium nitrate (LiNO %) solution, an aqueous lithium chloride (LiCl) solution, an aqueous lithium sulfate (Li₂SO₄) solution, an acetic acid solution of lithium acetate (LiOCOCH₃), and an ethanol solution of lithium acetate.

In the case of the incorporation of sodium (Na), examples of the solution include an aqueous sodium chloride (NaCl) solution, an aqueous sodium sulfate (Na₂SO₄) solution, and an aqueous sodium nitrate (NaNO₃).

In the case of the incorporation of potassium (K), examples of the solution include an aqueous potassium nitrate (KNO₃) solution, an aqueous potassium chloride (KCl) solution, an aqueous potassium sulfate (K₂SO₄) solution, an acetic acid solution of potassium acetate (KOCOCH₃), and an ethanol solution of potassium acetate.

In the case of the incorporation of rubidium (Rb), examples of the solution include an aqueous rubidium chloride (RbCl) solution and an aqueous rubidium nitrate (KNO₃) solution.

In the case of the incorporation of cesium (Cs), examples of the solution include an aqueous cesium chloride (CsCl), an aqueous cesium nitrate (CsNO₃) solution, and an aqueous cesium sulfate (Cs₂SO₄) solution.

In the case of the incorporation of francium (Fr), examples of the solution include an aqueous francium chloride (FrCl) solution.

In the case of the incorporation of calcium (Ca), examples of the solution include an aqueous calcium chloride (CaCl₂) solution and an aqueous calcium nitrate (Ca(NO₃)₂) solution.

In the case of the incorporation of strontium (Sr), examples of the solution include an aqueous strontium nitrate (Sr(NOO₃)₂) solution.

In the case of the incorporation of barium (Ba), examples of the solution include an aqueous barium chloride (BaCl₂) solution, an aqueous barium nitrate (Ba(NO₃)₂) solution, and an acetic acid solution of barium acetate (Ba(OCOCH₃)₂) solution.

The overall content of the main group element in the transition element-containing catalyst (with respect to the mass of the support in a state containing the transition element, the main group element, and so forth) is preferably at least 0.01 mass %, more preferably at least 0.05 mass %, still more preferably at least 0.1 mass %, particularly preferably at least 0.5 mass %, more particularly preferably at least 1.0 mass %, and most preferably at least 2.1 mass % and is preferably not more than 10 mass %, more preferably not more than 5 mass %, and still more preferably not more than 4 mass %. If within the indicated ranges, oligosilane production can be carried out more efficiently.

The transition element-containing catalyst may contain a Periodic Table group 13 main group element. There are no particular limitations on the form and composition of the Periodic Table group 13 main group element in the catalyst, and, for example, the form may be that of a metal (a metal simple substance, an alloy) optionally having an oxidized surface or may be that of a metal oxide (a single metal oxide, a composite metal oxide). For example, the metal oxide may be supported at the surface of the support (outer surface and/or within the pores) or the Periodic Table group 13 main group element may be introduced into the interior (support framework) by ion exchange or composite formation. The incorporation of a Periodic Table group 13 main group element can also restrain the initial hydrosilane (monosilane) conversion and inhibit excessive consumption, and in combination with this can raise the initial disilane selectivity. In addition, the catalyst life can also be extended by restraining the initial hydrosilane conversion.

Examples of the group 13 main group element include aluminum (Al), gallium (Ga), indium (In), and thallium (TI).

The method for incorporating the Periodic Table group 13 main group element into the transition element-containing catalyst is the same as that in the case of Periodic Table group 1 main group elements.

The content, the overall content, of the Periodic Table group 13 main group element in the transition element-containing catalyst (with respect to the mass of the support in a state containing the aforementioned transition element, main group element, and Periodic Table group 13 main group element) is preferably at least 0.01 mass %, more preferably at least 0.05 mass %, still more preferably at least 0.1 mass %, particularly preferably at least 0.5 mass %, more particularly preferably at least 1.0 mass %, and most preferably at least 2.1 mass % and is preferably not more than 10 mass %, more preferably not more than 5 mass %, and still more preferably not more than 4 mass %. If within the indicated ranges, oligosilane production can be carried out more efficiently.

### EXAMPLES

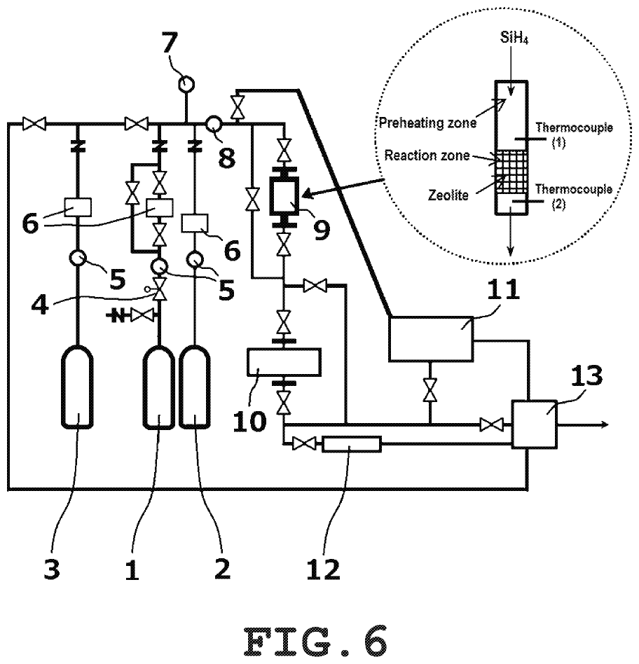

The present invention is described in additional detail using the Examples and Comparative Examples provided below, but modifications can be made as appropriate insofar as there is no departure from the essential features of the present invention. Accordingly, the scope of the present invention should not be construed as being limited to or by the specific examples given below. The Examples and Comparative Examples were carried out by immobilizing a zeolite in a fixed bed within a reaction tube of a reaction apparatus shown in FIG. 6 (schematic diagram) and flowing through a reaction gas containing tetrahydrosilane that had been diluted with helium gas or the like. The produced gas was analyzed using a GC-17A gas chromatograph from Shimadzu Corporation with a TCD (thermal conductivity detector). A yield of 0% was reported when detection by GC did not occur (below the detection limit). Qualitative analysis of the disilane and so forth was performed by a MASS (mass analyzer). The pores in the zeolites used were as follows.
ZSM-5 (framework type code: MFI, including H-ZSM-5):
   <100> minor diameter=0.51 nm, major diameter=0.55 nm
   <010> minor diameter=0.53 nm, major diameter=0.56 nm
SBeta (framework type code: BEA):
   <100> minor diameter=0.66 nm, major diameter=0.67 nm
   <001> minor diameter=0.56 nm, major diameter=0.56 nm

The numerical values for the pore minor diameter and major diameter are taken from “http://www.jaz-online.org/introduction/qanda.html” and “ATLAS OF ZEOLITE FRAMEWORK TYPES, Ch. Baerlocher, L. B. McCusker and D. H. Olson, Sixth Revised Edition 2007, published on behalf of the Structure Commission of the International Zeolite Association”.

A ½ inch stainless steel tube (nominal diameter: 12.7 mm, wall thickness: 1 mm, length: 500 mm) was manufactured and used as a reaction tube 9, and the reaction zone in FIG. 6 was filled with a catalyst (fill hight: approximately 10 cm). A commercially available tubular furnace (tubular furnace ARF-16KC from Heat Tech Co., Ltd., length: 14 cm) was placed in each of an upper portion (preheating zone) of the reaction tube not filled with the catalyst and a lower portion (reaction zone) of the reaction tube filled with the catalyst, and heating and cooling were performed at the temperatures given in the Examples and Comparative Examples.

Thermocouples (thermocouples (1), (2)) were inserted from the top and the bottom of the reaction tube to measure fluid temperatures at the inlet and outlet of the catalyst layer. Although a filter 10 in FIG. 6 was one generally used for sampling of a reaction gas, no sampling operation such as sampling by cooling was included in the Examples, and the reaction gas was directly introduced into the gas chromatograph for analysis. Since the reaction apparatus used in these evaluations was for testing and research, an abatement apparatus 13 was installed in order to discharge the products out of the system in a safe manner.

### Preparative Example 1: Preparation of Molybdenum (Mo)-Loaded Zeolite Pellets

Distilled water in an amount of 200 g and 3.70 g of (NH₄)₆Mo₇O₂₄4.H₂O (corresponding to a loading of 1 mass % as Mo) were added to 200 g of H-ZSM-5 pellets with a diameter of 3 mm (silica/alumina ratio=23, Tosoh Corporation, product name: HSZ type 822HOD3A, containing from 18 to 22 mass % alumina (SDS stated value)) and mixing was carried out for 1 hour at room temperature. Subsequently, the mixture was dried in the atmosphere for 4 hours at 110° C., and then fired in the atmosphere for 2 hours at 400° C., and additional 2 hours at 900° C. to provide 1 mass % Mo-loaded ZSM-5 (pellets).

### Preparative Example 2

Distilled water in an amount of 100 g and 2.38 g of Ba(NO₃)₂ (corresponding to a 2.4 mass % loading as Ba) were added to 50 g of the 1 mass % Mo-loaded ZSM-5 (silica/alumina ratio=23) prepared in Preparative Example 1 and mixing was carried out for 1 hour at room temperature. Subsequently, the mixture was dried in the atmosphere for 4 hours at 110° C., and then fired in the atmosphere for 2 hours at 700° C. to provide a 1 mass % Mo-loaded ZSM-5 (silica/alumina ratio=23) that contained 2.4 mass % of Ba.

### Preparative Example 3

Distilled water in an amount of 50 g and 7.8 g of a nitric acid solution of Pt(NH₃)₄(NO₁)₂ (Pt concentration: 6.4 mass %, from N.E. CHEMCAT Corporation) (corresponding to a loading of 1 mass % as Pt) were added to 50 g of H-ZSM-5 pellets with a diameter of 3 mm (silica/alumina ratio=23, Tosoh Corporation, product name: HSZ type 822HOD3A, containing from 18 to 22 mass % alumina (SDS stated value)) and mixing was carried out for 1 hour at room temperature. Subsequently, the mixture was dried at 110° C., and then fired for 1 hours at 700° C. to provide 1 mass % Pt-loaded ZSM-5 (pellets).

### Preparative Example 4

Distilled water in an amount of 50 g and 2.5 g of Co(NO₃)₂.6H₂O (corresponding to a loading of 1 mass % as Co) were added to 50 g of H-ZSM-5 pellets with a diameter of 3 mm (silica/alumina ratio=23. Tosoh Corporation, product name: HSZ type 822HOD3A, containing from 18 to 22 mass % alumina (SDS stated value)) and mixing was carried out for 1 hour at room temperature. Subsequently, the mixture was dried at 110° C., and then fired for 1 hours at 700° C. to provide 1 mass % Co-loaded ZSM-5 (pellets).

### Preparative Example 5: Preparation of Molybdenum (Mo)-Loaded Zeolite Pellets

Distilled water in an amount of 20 g and 0.37 g of (NH₄)₆Mo₇O₂₄.4H₂O (corresponding to a loading of 1 mass % as Mo) were added to 20 g of H-beta pellets with a diameter of 1.5 mm (silica/alumina ratio=17.1, Tosoh Corporation, product name: HSZ type 920HOD1A, containing from 18 to 22 mass % alumina (SDS stated value)) and mixing was carried out for 1 hour at room temperature. Subsequently, in the atmosphere, the mixture was dried in the atmosphere for 4 hours at 110° C., and then fired in the atmosphere for 6 hours at 600° C. to provide 1 mass % Mo-loaded Beta (pellets).

### Example 1

With the use of a 10 mL graduated cylinder, 10 cm³ of the 1 mass % Mo-loaded ZSM-5 (pellets) prepared in Preparative Example 1 was measured while being tapped, and then placed in the reaction tube. The air was removed from the reaction tube using a vacuum pump, and substitution with helium gas was then carried out. The helium gas was caused to flow through at a rate of 5 mL/minute, and two tubular furnaces were used, with one in the upper portion of the reaction tube set to 300° C. while the other in the lower portion set to 100° C. After the temperature was raised, throughflow was performed for 1 hour. Then, an argon/tetrahydrosilane (monosilane) mixed gas (Ar: 20%, SiH₄: 80% (molar ratio)) at 2 mL/minute, hydrogen gas at 2 mL/minute, and helium gas at 1 mL/minute were mixed in a gas mixer and caused to flow through. After 5 minutes, the argon/tetrahydrosilane (monosilane) mixed gas was brought to 4 mL/minute, the hydrogen gas was brought to 1 mL/minute, and the helium gas was stopped. Table 1 shows preset temperatures of the tubular furnaces and temperatures measured by the thermocouple (1) placed in the vicinity of the inlet of the reaction tube (reaction zone) and the thermocouple (2) placed in the vicinity of the outlet of the reaction tube (reaction zone) after each time period had elapsed from the stop of the helium gas. The composition of the reaction gas was analyzed by the gas chromatograph, and the tetrahydrosilane (monosilane) conversion, the hexahydrodisilane (disilane) yield, the selectivity for hexahydrodisilane (disilane), and the space-time yield (STY) of hexahydrodisilane (disilane) were calculated. The results are altogether given in Table 1. In the table, the “contact (residence) time” is the residence time within the reactor of the gas flowing through the reactor, i.e., it is the contact time between the hydrosilane and the catalyst. The space-time yield (STY) for hexahydrodisilane (disilane) was calculated using the following formula.

STY=mass of hexahydrodisilane (disilane) produced per hour/volume of catalyst

TABLE 1

| Preset temperatures of | | | | | | | | | | | | Contact | |
|---|---|---|---|---|---|---|---|---|---|---|---|---|---|
| tubular furnaces ° C. | | | | | | Measured temperatures of | | | Monosilane | Disilane | Disilane | (residence) | |
| | Lower | Time | Flow rate (mL/min) | | | reaction zone ° C. | | | conversion | yield | selectivity | time | STY |
| Upper portion | portion | (h) | Monosilane | Ar | H₂ | Inlet (1) | Outlet (2) | (1) − (2) | (%) | (%) | (%) | (sec) | (g/Lh) |
| 300 | 100 | 1 | 3.2 | 0.8 | 1 | 298 | 182 | 116 | 31.1 | 10.2 | 33 | 120 | 0.65 |
| 300 | 100 | 2 | 3.2 | 0.8 | 1 | 297 | 181 | 116 | 21.8 | 11.8 | 54 | 120 | 0.76 |
| 300 | 100 | 3 | 3.2 | 0.8 | 1 | 298 | 179 | 119 | 22.1 | 12.7 | 57 | 120 | 0.82 |
| 300 | 100 | 4 | 3.2 | 0.8 | 1 | 298 | 177 | 121 | 22.3 | 12.7 | 57 | 120 | 0.82 |
| 300 | 100 | 5 | 3.2 | 0.8 | 1 | 299 | 175 | 124 | 22.1 | 12.5 | 57 | 120 | 0.80 |
| 300 | 100 | 6 | 3.2 | 0.8 | 1 | 298 | 173 | 125 | 21.9 | 12.6 | 58 | 120 | 0.81 |

### Comparative Example 1

A reaction was carried out as in Example 1, except that the preset temperatures of the tubular furnaces were changed as shown in Table 2. The results are given in Table 2.

TABLE 2

| Preset temperatures of | | | | | | | | | | | | Contact | |
|---|---|---|---|---|---|---|---|---|---|---|---|---|---|
| tubular furnaces ° C. | | | | | | Measured temperatures of | | | Monosilane | Disilane | Disilane | (residence) | |
| | Lower | Time | Flow rate (mL/min) | | | reaction zone ° C. | | | conversion | yield | selectivity | time | STY |
| Upper portion | portion | (h) | Monosilane | Ar | H₂ | Inlet (1) | Outlet (2) | (1) − (2) | (%) | (%) | (%) | (sec) | (g/Lh) |
| 300 | 300 | 1 | 3.2 | 0.8 | 1 | 298 | 302 | −4 | 42.3 | 15.3 | 36 | 120 | 0.98 |
| 300 | 300 | 2 | 3.2 | 0.8 | 1 | 297 | 303 | −6 | 38.9 | 14.5 | 37 | 120 | 0.93 |
| 300 | 300 | 3 | 3.2 | 0.8 | 1 | 298 | 301 | −3 | 15.6 | 12.7 | 81 | 120 | 0.82 |
| 300 | 300 | 4 | 3.2 | 0.8 | 1 | 298 | 301 | −3 | 10.7 | 9.4 | 88 | 120 | 0.60 |
| 300 | 300 | 5 | 3.2 | 0.8 | 1 | 299 | 301 | −2 | 9.9 | 8.9 | 90 | 120 | 0.57 |
| 300 | 300 | 6 | 3.2 | 0.8 | 1 | 298 | 301 | −3 | 7.4 | 6.9 | 93 | 120 | 0.44 |

### Example 2, Comparative Example 2

Example 2 and Comparative Example 2 were respectively carried out as in Example 1 and Comparative Example 1, except that the catalyst was changed to 10 cm³ of the 1 mass % Mo-loaded ZSM-5 (silica/alumina ratio=23) that contained 2.4 mass % of Ba and was prepared in Preparative Example 2. The results of Example 2 and Comparative Example 2 are given in Tables 3 and 4, respectively.

TABLE 3

| Preset temperatures of | | | | | | | | | | | | Contact | |
|---|---|---|---|---|---|---|---|---|---|---|---|---|---|
| tubular furnaces ° C. | | | | | | Measured temperatures of | | | Monosilane | Disilane | Disilane | (residence) | |
| | Lower | Time | Flow rate (mL/min) | | | reaction zone ° C. | | | conversion | yield | selectivity | time | STY |
| Upper portion | portion | (h) | Monosilane | Ar | H₂ | Inlet (1) | Outlet (2) | (1) − (2) | (%) | (%) | (%) | (sec) | (g/Lh) |
| 300 | 100 | 1 | 3.2 | 0.8 | 1 | 298 | 175 | 123 | 25.4 | 12.6 | 50 | 120 | 0.81 |
| 300 | 100 | 2 | 3.2 | 0.8 | 1 | 297 | 172 | 125 | 17.6 | 13.8 | 78 | 120 | 0.89 |
| 300 | 100 | 3 | 3.2 | 0.8 | 1 | 298 | 169 | 129 | 17.4 | 14.1 | 81 | 120 | 0.91 |
| 300 | 100 | 4 | 3.2 | 0.8 | 1 | 298 | 169 | 129 | 17.5 | 13.9 | 79 | 120 | 0.89 |
| 300 | 100 | 5 | 3.2 | 0.8 | 1 | 299 | 165 | 134 | 17.2 | 14.0 | 81 | 120 | 0.90 |
| 300 | 100 | 6 | 3.2 | 0.8 | 1 | 298 | 166 | 132 | 17.3 | 14.1 | 82 | 120 | 0.91 |

TABLE 4

| Preset temperatures of | | | | | | | | | | | | Contact | |
|---|---|---|---|---|---|---|---|---|---|---|---|---|---|
| tubular furnaces ° C. | | | | | | Measured temperatures of | | | Monosilane | Disilane | Disilane | (residence) | |
| | Lower | Time | Flow rate (mL/min) | | | reaction zone ° C. | | | conversion | yield | selectivity | time | STY |
| Upper portion | portion | (h) | Monosilane | Ar | H₂ | Inlet (1) | Outlet (2) | (1) − (2) | (%) | (%) | (%) | (sec) | (g/Lh) |
| 300 | 300 | 1 | 3.2 | 0.8 | 1 | 298 | 301 | −3 | 34.5 | 13.8 | 40 | 120 | 0.89 |
| 300 | 300 | 2 | 3.2 | 0.8 | 1 | 297 | 300 | −3 | 28.9 | 12.6 | 44 | 120 | 0.81 |
| 300 | 300 | 3 | 3.2 | 0.8 | 1 | 298 | 299 | −1 | 21.3 | 14.6 | 69 | 120 | 0.94 |
| 300 | 300 | 4 | 3.2 | 0.8 | 1 | 298 | 298 | 0 | 15.6 | 12.3 | 79 | 120 | 0.79 |
| 300 | 300 | 5 | 3.2 | 0.8 | 1 | 299 | 299 | 0 | 12.3 | 10.3 | 84 | 120 | 0.66 |
| 300 | 300 | 6 | 3.2 | 0.8 | 1 | 298 | 301 | −3 | 10.6 | 9.1 | 86 | 120 | 0.58 |

### Example 3, Comparative Example 3

Example 3 and Comparative Example 3 were respectively carried out as in Example 1 and Comparative Example 1, except that the catalyst was changed to 10 cm³ of the 1 mass % Pt-loaded ZSM-5 (pellets) prepared in Preparative Example 3. The results of Example 3 and Comparative Example 3 are given in Tables 5 and 6, respectively.

TABLE 5

| Preset temperatures of | | | | | | | | | | | | Contact | |
|---|---|---|---|---|---|---|---|---|---|---|---|---|---|
| tubular furnaces ° C. | | | | | | Measured temperatures of | | | Monosilane | Disilane | Disilane | (residence) | |
| | Lower | Time | Flow rate (mL/min) | | | reaction zone ° C. | | | conversion | yield | selectivity | time | STY |
| Upper portion | portion | (h) | Monosilane | Ar | H₂ | Inlet (1) | Outlet (2) | (1) − (2) | (%) | (%) | (%) | (sec) | (g/Lh) |
| 300 | 100 | 1 | 3.2 | 0.8 | 1 | 298 | 206 | 92 | 43.1 | 22.1 | 51 | 120 | 1.42 |
| 300 | 100 | 2 | 3.2 | 0.8 | 1 | 297 | 201 | 96 | 38.9 | 18.9 | 49 | 120 | 1.21 |
| 300 | 100 | 3 | 3.2 | 0.8 | 1 | 298 | 198 | 100 | 25.6 | 12.5 | 49 | 120 | 0.80 |
| 300 | 100 | 4 | 3.2 | 0.8 | 1 | 298 | 196 | 102 | 22.3 | 10.8 | 48 | 120 | 0.69 |
| 300 | 100 | 5 | 3.2 | 0.8 | 1 | 299 | 189 | 110 | 18.9 | 9.8 | 52 | 120 | 0.63 |
| 300 | 100 | 6 | 3.2 | 0.8 | 1 | 298 | 188 | 110 | 16.7 | 8.9 | 53 | 120 | 0.57 |

TABLE 6

| Preset temperatures of | | | | | | | | | | | | Contact | |
|---|---|---|---|---|---|---|---|---|---|---|---|---|---|
| tubular furnaces ° C. | | | | | | Measured temperatures of | | | Monosilane | Disilane | Disilane | (residence) | |
| | Lower | Time | Flow rate (mL/min) | | | reaction zone ° C. | | | conversion | yield | selectivity | time | STY |
| Upper portion | portion | (h) | Monosilane | Ar | H₂ | Inlet (1) | Outlet (2) | (1) − (2) | (%) | (%) | (%) | (sec) | (g/Lh) |
| 300 | 300 | 1 | 3.2 | 0.8 | 1 | 298 | 310 | −12 | 50.8 | 21.3 | 42 | 120 | 1.37 |
| 300 | 300 | 2 | 3.2 | 0.8 | 1 | 297 | 308 | −11 | 39.2 | 17.9 | 46 | 120 | 1.15 |
| 300 | 300 | 3 | 3.2 | 0.8 | 1 | 298 | 306 | −8 | 20.4 | 10.2 | 50 | 120 | 0.66 |
| 300 | 300 | 4 | 3.2 | 0.8 | 1 | 298 | 302 | −4 | 15.3 | 10.1 | 66 | 120 | 0.65 |
| 300 | 300 | 5 | 3.2 | 0.8 | 1 | 299 | 300 | −1 | 10.3 | 8.9 | 86 | 120 | 0.57 |
| 300 | 300 | 6 | 3.2 | 0.8 | 1 | 298 | 301 | −3 | 7.8 | 6.7 | 86 | 120 | 0.43 |

### Example 4, Comparative Example 4

Example 4 and Comparative Example 4 were respectively carried out as in Example 1 and Comparative Example 1, except that the catalyst was changed to 10 cm³ of the 1 mass % Co-loaded ZSM-5 (pellets) prepared in Preparative Example 4. The results of Example 4 and Comparative Example 4 are given in Tables 7 and 8, respectively.

TABLE 7

| Preset temperatures of | | | | | | | | | | | | Contact | |
|---|---|---|---|---|---|---|---|---|---|---|---|---|---|
| tubular furnaces ° C. | | | | | | Measured temperatures of | | | Monosilane | Disilane | Disilane | (residence) | |
| | Lower | Time | Flow rate (mL/min) | | | reaction zone ° C. | | | conversion | yield | selectivity | time | STY |
| Upper portion | portion | (h) | Monosilane | Ar | H₂ | Inlet (1) | Outlet (2) | (1) − (2) | (%) | (%) | (%) | (sec) | (g/Lh) |
| 300 | 100 | 1 | 3.2 | 0.8 | 1 | 298 | 198 | 100 | 38.9 | 23.1 | 59 | 120 | 1.48 |
| 300 | 100 | 2 | 3.2 | 0.8 | 1 | 297 | 199 | 98 | 35.6 | 19.8 | 56 | 120 | 1.27 |
| 300 | 100 | 3 | 3.2 | 0.8 | 1 | 298 | 197 | 101 | 28.9 | 16.2 | 56 | 120 | 1.04 |
| 300 | 100 | 4 | 3.2 | 0.8 | 1 | 298 | 196 | 102 | 25.6 | 14.4 | 56 | 120 | 0.93 |
| 300 | 100 | 5 | 3.2 | 0.8 | 1 | 299 | 195 | 104 | 23.4 | 13.8 | 59 | 120 | 0.89 |
| 300 | 100 | 6 | 3.2 | 0.8 | 1 | 298 | 192 | 106 | 19.8 | 11.8 | 60 | 120 | 0.76 |

TABLE 8

| Preset temperatures of | | | | | | | | | | | | Contact | |
|---|---|---|---|---|---|---|---|---|---|---|---|---|---|
| tubular furnaces ° C. | | | | | | Measured temperatures of | | | Monosilane | Disilane | Disilane | (residence) | |
| | Lower | Time | Flow rate (mL/min) | | | reaction zone ° C. | | | conversion | yield | selectivity | time | STY |
| Upper portion | portion | (h) | Monosilane | Ar | H₂ | Inlet (1) | Outlet (2) | (1) − (2) | (%) | (%) | (%) | (sec) | (g/Lh) |
| 300 | 300 | 1 | 3.2 | 0.8 | 1 | 298 | 308 | −10 | 49.7 | 22.5 | 45 | 120 | 1.45 |
| 300 | 300 | 2 | 3.2 | 0.8 | 1 | 297 | 305 | −8 | 38.7 | 17.9 | 46 | 120 | 1.15 |
| 300 | 300 | 3 | 3.2 | 0.8 | 1 | 298 | 304 | −6 | 30.3 | 14.5 | 48 | 120 | 0.93 |
| 300 | 300 | 4 | 3.2 | 0.8 | 1 | 298 | 303 | −5 | 16.5 | 8.7 | 53 | 120 | 0.56 |
| 300 | 300 | 5 | 3.2 | 0.8 | 1 | 299 | 302 | −3 | 12.3 | 7.9 | 64 | 120 | 0.51 |
| 300 | 300 | 6 | 3.2 | 0.8 | 1 | 298 | 302 | −4 | 8.8 | 7.1 | 81 | 120 | 0.46 |

### Example 5, Comparative Examples 5 and 6

Example 5 and Comparative Example 5 were respectively carried out as in Example 1 and Comparative Example 1, except that the catalyst was changed to 10 cm³ of the 1 mass % Mo Beta (pellets) prepared in Preparative Example 5. The results of Example 5 and Comparative Example 5 are given in Tables 9 (Example 5) and 10 (Comparative Example 5), respectively. Comparative Example 6 was carried out as in Comparative Example 5, except that the temperature of the tubular furnace in the upper portion of the reaction tube was changed to 200° C., and that the temperature of the reaction furnace in the lower portion of the reaction tube was changed to 400° C. The results are given in Table 11 (Comparative Example 6).

TABLE 9

| Preset temperatures of | | | | | | | | | | | | Contact | |
|---|---|---|---|---|---|---|---|---|---|---|---|---|---|
| tubular furnaces ° C. | | | | | | Measured temperatures of | | | Monosilane | Disilane | Disilane | (residence) | |
| | Lower | Time | Flow rate (mL/min) | | | reaction zone ° C. | | | conversion | yield | selectivity | time | STY |
| Upper portion | portion | (h) | Monosilane | Ar | H₂ | Inlet (1) | Outlet (2) | (1) − (2) | (%) | (%) | (%) | (sec) | (g/Lh) |
| 300 | 100 | 1 | 3.2 | 0.8 | 1 | 298 | 178 | 120 | 28.4 | 10.3 | 36 | 120 | 0.66 |
| 300 | 100 | 2 | 3.2 | 0.8 | 1 | 297 | 177 | 120 | 19.8 | 11.3 | 57 | 120 | 0.73 |
| 300 | 100 | 3 | 3.2 | 0.8 | 1 | 298 | 175 | 123 | 18.7 | 12.1 | 65 | 120 | 0.78 |
| 300 | 100 | 4 | 3.2 | 0.8 | 1 | 298 | 173 | 125 | 18.5 | 11.9 | 64 | 120 | 0.76 |
| 300 | 100 | 5 | 3.2 | 0.8 | 1 | 299 | 173 | 126 | 18.4 | 11.6 | 63 | 120 | 0.75 |
| 300 | 100 | 6 | 3.2 | 0.8 | 1 | 298 | 173 | 125 | 18.3 | 11.7 | 64 | 120 | 0.75 |

TABLE 10

| Preset temperatures of | | | | | | | | | | | | Contact | |
|---|---|---|---|---|---|---|---|---|---|---|---|---|---|
| tubular furnaces ° C. | | | | | | Measured temperatures of | | | Monosilane | Disilane | Disilane | (residence) | |
| | Lower | Time | Flow rate (mL/min) | | | reaction zone ° C. | | | conversion | yield | selectivity | time | STY |
| Upper portion | portion | (h) | Monosilane | Ar | H₂ | Inlet (1) | Outlet (2) | (1) − (2) | (%) | (%) | (%) | (sec) | (g/Lh) |
| 300 | 300 | 1 | 3.2 | 0.8 | 1 | 298 | 301 | −3 | 35.9 | 12.3 | 34 | 120 | 0.79 |
| 300 | 300 | 2 | 3.2 | 0.8 | 1 | 297 | 302 | −5 | 24.5 | 12.3 | 50 | 120 | 0.79 |
| 300 | 300 | 3 | 3.2 | 0.8 | 1 | 298 | 301 | −3 | 18.9 | 12.8 | 68 | 120 | 0.82 |
| 300 | 300 | 4 | 3.2 | 0.8 | 1 | 298 | 301 | −3 | 15.4 | 9.8 | 64 | 120 | 0.63 |
| 300 | 300 | 5 | 3.2 | 0.8 | 1 | 299 | 301 | −2 | 13.4 | 8.2 | 61 | 120 | 0.53 |
| 300 | 300 | 6 | 3.2 | 0.8 | 1 | 298 | 301 | −3 | 11.2 | 8.1 | 72 | 120 | 0.52 |

TABLE 11

| Preset temperatures of | | | | | | | | | | | | Contact | |
|---|---|---|---|---|---|---|---|---|---|---|---|---|---|
| tubular furnaces ° C. | | | | | | Measured temperatures of | | | Monosilane | Disilane | Disilane | (residence) | |
| | Lower | Time | Flow rate (mL/min) | | | reaction zone ° C. | | | conversion | yield | selectivity | time | STY |
| Upper portion | portion | (h) | Monosilane | Ar | H₂ | Inlet (1) | Outlet (2) | (1) − (2) | (%) | (%) | (%) | (sec) | (g/Lh) |
| 200 | 400 | 1 | 3.9 | 0.8 | 1 | 197 | 389 | −192 | 31.9 | 9.1 | 29 | 120 | 0.58 |
| 200 | 400 | 2 | 3.2 | 0.8 | 1 | 196 | 392 | −196 | 22.3 | 7.8 | 35 | 120 | 0.50 |
| 200 | 400 | 3 | 3.2 | 0.8 | 1 | 198 | 395 | −197 | 14.5 | 7.7 | 53 | 120 | 0.49 |
| 200 | 400 | 4 | 3.2 | 0.8 | 1 | 197 | 392 | −195 | 12.3 | 7.4 | 60 | 120 | 0.48 |
| 200 | 400 | 5 | 3.2 | 0.8 | 1 | 197 | 391 | −194 | 11.8 | 7.5 | 64 | 120 | 0.48 |
| 200 | 400 | 6 | 3.2 | 0.8 | 1 | 197 | 391 | −194 | 11.6 | 7.3 | 63 | 120 | 0.47 |

In Comparative Examples 1 to 5, although initial activity was high as compared with Examples 1 to 5, catalyst deactivation was fast, which demonstrates that reaction results failed rapidly. In Comparative Example 6, activity was low from the initial stage, and the production efficiency was lower than that in Examples 1 to 5 and Comparative Examples 1 to 5.

### INDUSTRIAL APPLICABILITY

Oligosilanes produced by the production method of the present invention are expected to be used as a gas for the production of silicon for semiconductors.

### REFERENCE SIGNS LIST

101 Reactor
102 Introduction pipe
103 Delivery pipe
104 Fluid containing hydrosilane (raw material)
105 Fluid containing oligosilane (product)
106 Catalyst layer
107, 108 Thermocouple
201, 301, 401 Reactor
202, 302, 402 Introduction pipe
203, 303, 403 Delivery pipe
204, 304, 404 Fluid containing hydrosilane (raw material)
205, 305, 405 Fluid containing oligosilane (product)
206, 306, 406 Temperature control unit
207, 307, 407 Catalyst layer
501 Reactor
502 Introduction pipe
503 Delivery pipe
504 Fluid containing hydrosilane (raw material)
505 Fluid containing oligosilane (product)
506 Temperature control unit
507 Catalyst layer
1 Tetrahydrosilane gas cylinder
   (containing 20 mol % Ar)
2 Hydrogen gas cylinder
3 Helium gas cylinder
4 Emergency shutoff valve (shutoff valve linked with gas detection)
5 Pressure reduction valve
6 Mass flow controller
7 Pressure gauge
8 Gas mixer
9 Reaction tube
10 Filter
11 Rotary pump
12 Gas chromatograph
13 Abatement apparatus

1. A method for producing an oligosilane, comprising a reaction step of introducing a fluid containing a hydrosilane into a continuous reactor provided with a catalyst layer inside to produce an oligosilane from the hydrosilane and discharging a fluid containing the oligosilane from the reactor, wherein
the reaction step satisfies all of the following conditions (i) to (iii):
(i) a temperature of the hydrosilane-containing fluid at an inlet of the catalyst layer is higher than a temperature of the oligosilane-containing fluid at an outlet of the catalyst layer;
(ii) the temperature of the hydrosilane-containing fluid at the inlet of the catalyst layer is from 200 to 400° C.; and
(iii) the temperature of the oligosilane-containing fluid at the outlet of the catalyst layer is from 50 to 300° C.

2. The method for producing an oligosilane according to claim 1, wherein
the temperature of the hydrosilane-containing fluid at the inlet of the catalyst layer is from 10 to 200° C. higher than the temperature of the oligosilane-containing fluid at the outlet of the catalyst layer.

3. The method for producing an oligosilane according to claim 1, wherein
the hydrosilane-containing fluid is a gas containing hydrogen gas, and
the hydrogen gas has a concentration of from 1 to 40 mol % in the hydrosilane-containing fluid.

4. The oligosilane production method according to claim 1, wherein
the hydrosilane has a concentration of from 20 mol % to 95 mol % in the hydrosilane-containing fluid.

5. The oligosilane production method according to claim 1, wherein
the hydrosilane-containing fluid is a gas, and
the gas has a pressure of from 0.1 to 10 MPa at the inlet of the catalyst layer.

6. The method for producing an oligosilane according to claim 1, wherein
the hydrosilane is tetrahydrosilane, and
the oligosilane includes hexahydrodisilane.

7. The method for producing an oligosilane according to claim 1, wherein
the catalyst layer comprises a catalyst containing, on the surface and/or in the interior of a support, at least one transition element selected from the group consisting of Periodic Table group 3 transition elements, group 4 transition elements, group 5 transition elements, group 6 transition elements, group 7 transition elements, group 8 transition elements, group 9 transition elements, group 10 transition elements, and group 11 transition elements.

8. The method for producing an oligosilane according to claim 7, wherein
the support is at least one selected from the group consisting of silica, alumina, titania, zirconia, zeolite, and activated carbon.

9. The method for producing an oligosilane according to claim 8, wherein
the zeolite has pores with a minor diameter of at least 0.41 nm and a major diameter of not more than 0.74 nm.

10. The method for producing an oligosilane according to claim 8, wherein
the support is a spherical or cylindrical molding of alumina as binder and a powder containing a zeolite having pores with a minor diameter of at least 0.41 nm and a major diameter of not more than 0.74 nm, and has an alumina content (per 100 mass parts of the support not containing the alumina) of at least 10 mass parts and not more than 30 mass parts.

11. The method for producing an oligosilane according to claim 7, wherein
the transition element is at least one transition element selected from the group consisting of Periodic Table group 4 transition elements, group 5 transition elements, group 6 transition elements, group 8 transition elements, group 9 transition elements, group 10 transition elements, and group 11 transition elements.

12. The method for producing an oligosilane according to claim 11, wherein
the transition element is at least one transition element selected from the group consisting of Periodic Table group 5 transition elements, group 6 transition elements, group 9 transition elements, and group 10 transition elements.

13. The method for producing an oligosilane according to claim 12, wherein
the transition element is at least one transition element selected from the group consisting of tungsten (W), molybdenum (Mo), cobalt (Co), and platinum (Pt).

14. The method for producing an oligosilane according to claim 7, wherein
the catalyst comprises zeolite as the support and further contains, on the surface and/or in the interior of the zeolite, at least one main group element selected from the group consisting of Periodic Table group 1 main group elements and group 2 main group elements.
